(19) United States
(12) Patent Application Publication
(10) Pub. No.: US 2009/0010150 A1
(43) Pub. Date: Jan. 8, 2009

(54) Apparatus for Band Limiting in Sc-Fdma Communications Systems and Method Thereof

(76) Inventors: Hak Seong Kim, Seoul (KR); Bong Hoe Kim, Gyeonggi-do (KR); Dong Wook Roh, Seoul (KR); Joon Kui Ahn, Seoul (KR); Dong Youn Seo, Seoul (KR)

Correspondence Address: LEE, HONG, DEGERMAN, KANG & WAIMEY, 660 S. FIGUEROA STREET, Suite 2300, LOS ANGELES, CA, 90017, US

(21) Appl. No.: 11/913,536

(22) PCT Filed: May 2, 2006
(86) PCT No.: PCT/KR2006/001647

§ 371 Date: Jun. 27, 2008

(30) Foreign Application Priority Data
May 2, 2005 (KR) 10-2005-0036819

(51) Int. Cl. H04J 11/00; H04J 1/00

(52) U.S. Cl. 370/210; 370/344

(57) ABSTRACT

A method for band limiting in a Single Carrier Frequency Division Multiple Access (SC-FDMA) communications system comprises generating a SC-FDMA data symbol block and band-limiting the SC-FDMA data symbol block using a window (309). A transmitter in a SC-FDMA communications system comprises a SC-FDMA data symbol block generator which generates a SC-FDMA data symbol block and a window (309) for band limiting the SC-FDMA data symbol block. Using a window (309) for band limiting has an advantage to decrease the number of calculations because only multiplication's between the transmitted signal and the window (309) are required.

### FIELD OF THE INVENTION

The present invention relates to Single-Carrier Frequency Division Multiple Access (SC-FDMA) communications systems, and more particularly, to an apparatus for band limiting in SC-FDMA communications systems and a method thereof.

### DISCUSSION OF THE RELATED ART

In general, there are three types of multiple access methods, namely, Frequency Division Multiple Access (FDMA), Time Division Multiple Access (TDMA), and Code Division Multiple Access (CDMA).

Frequency Division Multiple Access (FDMA) is a form of signal multiplexing where multiple baseband signals are modulated on different frequency carrier waves and added together to create a composite signal.

Time Division Multiple Access (TDMA) allows a number of users to access a single radio-frequency (RF) channel without interference by allocating unique time slots to each user within each channel.

Code Division Multiple Access (CDMA) does not divide up the channel by time (as in TDMA), or frequency (as in FDMA), but instead encodes data with a special code associated with each channel and uses the constructive interference properties of the special codes to perform the multiplexing. CDMA is further divided as Direct Sequence CDMA (DS-CDMA), Frequency Hopping CDMA (FH-CDMA) and a hybrid of both by how to spread signals. The DS-CDMA chops the data into small pieces and spreads them across the frequency domain. In an FH-CDMA system, a transmitter “hops” between available frequencies according to a specified algorithm, which can be either random or preplanned.

A single-carrier system may utilize single-carrier frequency division multiple access (SC-FDMA), code division multiple access (CDMA), or some other single-carrier modulation scheme. A SC-FDMA system may utilize (1) interleaved FDMA (IFDMA) to transmit data and pilot on subcarriers that are distributed across the overall system bandwidth (2) localized FDMA (LFDMA) to transmit data and pilot on a group of adjacent subcarriers, or (3) enhanced FDMA (EFDMA) to transmit data and pilot on multiple groups of adjacent subcarriers. In general, modulation symbols are sent in the time domain with SC-FDMA (e.g., IFDMA, LFDMA, and EFDMA) and in the frequency domain with OFDM.

FIG. 1 illustrates a symbol structure of the first type of Single-Carrier Frequency Division Multiple Access (SC-FDMA) communications systems, i.e., the Interleaved Frequency Division Multiple Access (IFDMA) communications system. The IFDMA transmits Q symbol data repeated L times. Q symbol sequences are described as

dⁱ=└d₀ⁱd₁ⁱ . . . d_{Q-1}ⁱ┘ where i is an index for a specific user.

When transmitting symbol sequences according to the IFDMA method, a Guard Interval is formed to avoid interferences between data blocks. The length of the Guard Interval should be larger than the delay time of the channel. The guard interval and the repeated symbol block together form an IFDMA symbol as shown in FIG. 1. An IFDMA symbol cᵢ can be expressed as:

$${c}^{i} = \frac{1}{L + {L}_{Δ}} \underbrace{[ \begin{matrix}{d}_{0}^{i} & {d}_{1}^{i} … {d}_{Q - 1}^{i} … {d}_{0}^{i} & {d}_{1}^{i} … {d}_{Q - 1}^{i}\end{matrix} ]}_{L - {L}_{Δ} times} \qquad ( Equation 1 )$$

For example, the FIG. 1 shows an IFDMA symbol cⁱ when the length of Guard Interval L_{Δ}=2, the repeat time of symbol sequence L=8, and the number of symbols Q=5.

Also, the Ith component of an IFDMA symbol for a user i, that is, the Ith complex symbol data for a user i can be expressed as:

$${c}_{l}^{i} = \frac{1}{L + {L}_{Δ}} {d}_{i mod Q}^{i} , l = L , … , {L}_{c} ( = Q ( L + {L}_{Δ} ) )$$

where L_{c} is the dimension of the IFDMA symbol cⁱ.

The data symbol block generated by FIG. 1 is transmitted user-dependent phase shift to distinguish users. The data block is multiplied by the user-dependent phase vector, where the user-dependent phase vector s(i) of dimension Lc having components

s⁽ⁱ⁾ₗ=exp(−j·l·Φⁱ),l=0, . . . , L_{c}−1, (L_{c}=(L+L_{Δ})Q

The user-dependent phase φ⁽ⁱ⁾ is chosen to be

$${Φ}^{( i )} = i \times \frac{2 π}{Q \times L}$$

Finally, the resulting transmission signal vector Xⁱ can be written as

$${x}^{i} = [ \begin{matrix}{c}_{0}^{i} & {c}_{1}^{i} {e}^{- j {Φ}^{i}} … {c}_{{L}_{c} - 0}^{i} {e}^{- j ( {L}_{c} - 1 ) {Φ}^{i}}\end{matrix} ] \qquad ( Equation 2 )$$

The each transmission signal Xᵢ is located to different frequency because each signal generates different phase delay.

FIG. 2 shows a structure of an OFDM (Orthogonal Frequency Division Multiplexing)-FDMA (Frequency Division Multiple Access) transmitter (200) which is one of SC-FDMA systems with a pulse shaping filter (209).

In this case, M different users are considered and each user allocates L different subcarriers exclusively. The total number of subcarriers in the considered transmission system is No=L*M. The input data stream for each mobile user m, m=0, . . . , M−1, is convolutionally encoded at encoder & interleaver (201). The bit sequence is then mapped onto L complex modulation symbols D_{I}^{(m)}, I=0, . . . , L−1, of a coherent, higher-level modulation scheme (202). After serial to parallel conversion (203), the L modulation symbols are spread over the L user specifically allocated subcarriers with an unitary spreading matrix [C] (204) resulting in L complex transmit symbols S_{I}^{(m)}. The transmit symbols S_{I}^{(m)} are then mapped onto L of the available No subcarriers which are exclusively allocated to user m at FDMA-Mapping (205). The IFFT (206) converts the transmit symbols S_{I}^{(m)} into the transmit time signal s_{I}^{(m)}. The parallel to serial converter (207) converts the parallel transmit time signal into the serial transmit time signal. The transmit time signal s_{I}^{(m)} of user m in an OFDM-FDMA uplink using DFT spreading matrix and an equidistant subcarrier allocation results therefore in a periodic repetition of the complex user data symbol D_{I}^{(m)} sequence including an added guard interval as cyclic prefix (208).

Moreover, most transmission systems have band limitations imposed by either the natural bandwidth of the transmission medium (copper wire, coaxial cable, optical fiber, etc.) or by governmental or regulatory conditions. Thus, the challenge in data transmission systems is to obtain the highest possible data rate in the bandwidth allotted with the least number of errors (preferably none). However, the trouble with the rectangular pulse is that it has significant energy over a fairly large bandwidth as indicated by its Fourier transform. In fact, because the spectrum of the pulse is given by the familiar sinc response; its bandwidth actually extends infinity. The unbounded frequency response of the rectangular pulse renders it unsuitable for modern transmission systems. This is where pulse shaping filters (209) come into play. The square root raised cosine filter as a pulse shaping filter among others is widely used in Digital Communications Systems to remove the effects of Intersymbol Interference (ISI) that occurs over channels affected by fading distortion. The square root Raised cosine filter may be synthesized directly from the impulse response, which is:

$$f ( t ) = \sqrt{\frac{sin ( π t / T )}{π t / T} \frac{cos ( β π t / T )}{1 - 4 {β}^{2} {t}^{2} / {T}^{2}}} \qquad ( Equation 3 )$$

where T is the sampling period and B is a ratio of signal bandwidth and excess bandwidth.

However, the basic filtering process is synonymous with convolution in the time domain and digital filters require a convolution operation. The band limiting method using the pulse shaping filter needs a number of convolution operations between the final transmit signal and filter coefficients, thereby increasing the number of calculations. Also, the band limiting using one of pulse shaping filters increases the peak power since multiplications between the final transmit signal and filter coefficients and additions between those multiplications are repeated several times for convolution operations. In other words, the peak-to-average power ratio (PAPR) increases so dramatically that the operating points of amplifiers can be changed or the heavy loads may be given to other elements.

Therefore, it is highly desired to develop a technology which provides fewer calculations for band limiting in SC-FDMA communications systems.

### SUMMARY OF THE INVENTION

Accordingly, the present invention is directed to an apparatus for band limiting in a SC-FDMA communications system and a method thereof that substantially obviates one or more problems due to limitations and disadvantages of the related art.

An object of the present invention is to provide a device and method for band limiting in a SC-FDMA communications system with fewer calculations.

Another object of the present invention is to provide a device and method for band limiting in a SC-FDMA communications system with less time delay.

A further object of the present invention is to provide a device and method for band limiting in a SC-FDMA communications system with low PAPR.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein a method for band limiting in a SC-FDMA communications system comprising receiving a SC-FDMA data symbol block and band-limiting the SC-FDMA data symbol block using a window.

In another aspect of the present invention, a transmitter in a SC-FDMA communications system comprises a SC-FDMA data symbol block generator which generates a SC-FDMA data symbol block and a window for band limiting the SC-FDMA data symbol block.

It is to be understood that both the foregoing general description and the following detailed description of the present invention are exemplary and explanatory and are intended to provide further explanation of the invention as claimed. The word “exemplary” is used herein to mean “serving as an example, instance, or illustration.” Any embodiment described herein as “exemplary” is not necessarily to be construed as preferred or advantageous over other embodiments.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a structure of an IFDMA-symbol c⁽ⁱ⁾ for user 1, L_{Δ}=2, L=8 and Q=5;

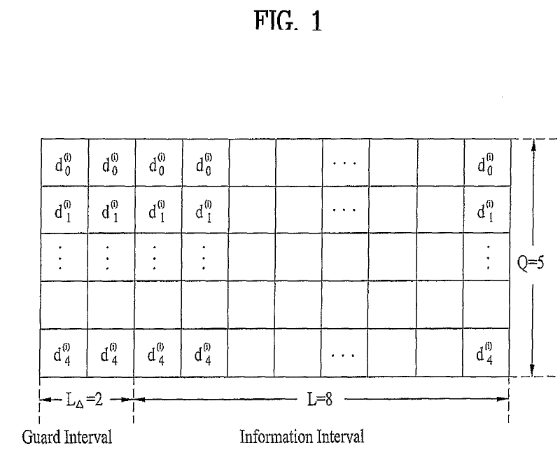

FIG. 2 illustrates an OFDM-FDMA transmitter with DFT spreading over equidistant subcarriers with a pulse shaping filter;

FIG. 3 illustrates an OFDM-FDMA transmitter with DFT spreading over equidistant subcarriers with a window;

FIG. 4 illustrates a rectangular window; and

FIG. 5 illustrates a band limiting effect when a window is used, compared when window is not used.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

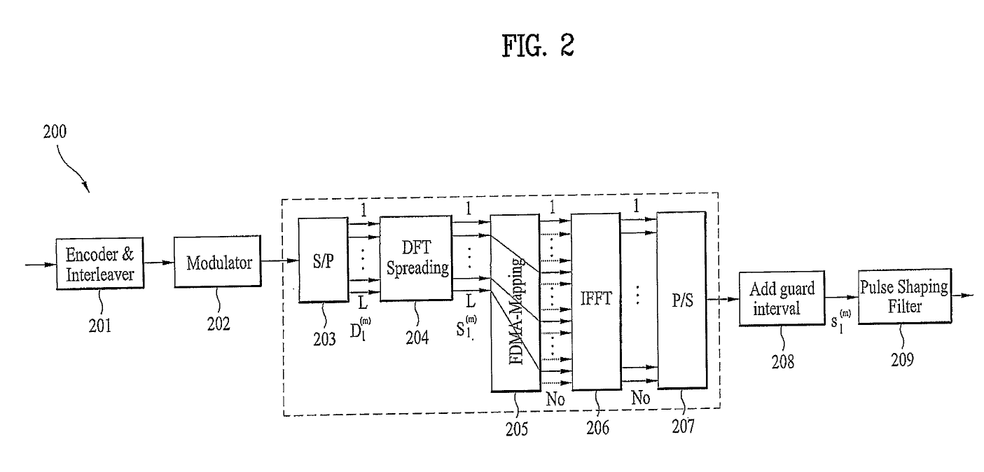

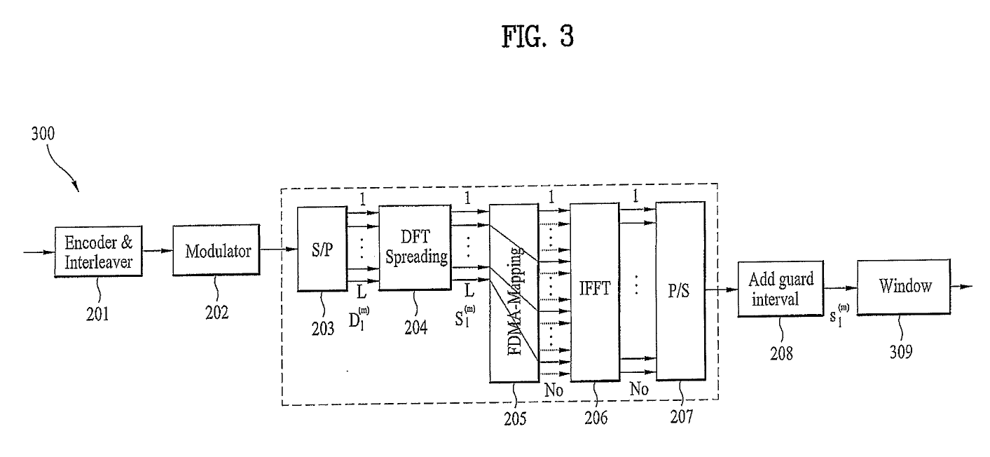

Turning now to the drawings, FIG. 3 shows a structure of an OFDM (Orthogonal Frequency Division Multiplexing)-FDMA (Frequency Division Multiple Access) transmitter (300) which is one of SC-FDMA systems with a window (309), instead of the pulse shaping filter (209) in FIG. 2. As will be described in further detail in below, the window (309) has many advantages over the pulse shaping filter (209). Windowing is a technique used to shape the time portion of measurement data, to minimize edge effects that result in spectral leakage in the FFT spectrum. By using windows correctly, the spectral resolution of frequency-domain result will increase.

The band limiting of the SC-FDMA wireless mobile communications system comprises generating a window for band limiting and limiting the band using the window. The length of the window depends on the number of SC-FDMA symbols and the window has specific lengths of Window head and window tail. The window W(n), as an example, can be described as

$$W ( n ) = \frac{n}{Nh} , 1 \leq n \leq Nh ( Period 1 ) 1 , Nh + 1 \leq n \leq N + N p + Nh ( period 2 ) \frac{( Nh + N + N p + Nt - n )}{Nt} , N + N p + Nh + 1 \leq n \leq N + N p + Nh + Nt ( period 3 )$$

where n is an index number of each SC-FDMA symbol, Nh is the length of the window head, Nt is the length of the tail, N is the number of SC-FDMA symbols in an information interval and Np is the number of SC-FDMA symbols in a guard interval.

The W(n) can be repeated by every N+Np that the tail window of one W(n) is overlapped in part or whole by the head window of next W(n).

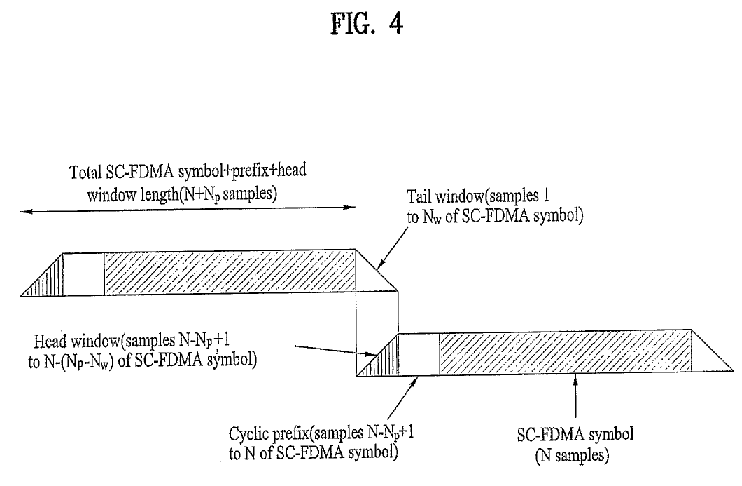

FIG. 4 shows a rectangular window applied to the SC-FDMA system. In the figure, the window comprises a head window, a cyclic prefix, SC-FDMA symbols and a tail window. In this example, the head window and the tail window have the same length, namely Nw. The cyclic prefix has a length of Np where NP=Q*L_{Δ}, the number of symbols in the Guard Interval. The SC-FDMA symbols has a length of N where N=Q*L, the number of symbols in the Information Interval.

The Equation 5 below is a specific example of the window (Equation 4) when Nw=Nh=Nt=32.

$$W ( n ) = \frac{n}{32} , 1 \leq n \leq 32 ( Period 1 ) 1 , 33 \leq n \leq N + N p + 32 ( period 2 ) \frac{( 64 + N + N p - n )}{32} , N + N p + 33 \leq n \leq N + N p + 64 ( period 3 ) \qquad ( Equation 5 )$$

The window W(n) is multiplied by the transmitted signal x[n] of the SC-FDMA system to make the actual transmitted signal. In other words, the actual transmitted signal is the transmitted signal x[n] multiplied by the window W(n). When n, the index number of each SC-FDMA symbol, is in the period 1, the transmitted signal x[n] is multiplied by the linear area of the window W(n).

The linear window shown in the figure is just for an example and the window can be any type including non-linear windows. When n is in the period 2, x[n] is multiplied by unity where x[n] includes symbols in the information interval or symbols in both the information interval and the guard interval. Also, since x[n] is multiplied by unity in the time domain in the period 2, the band limiting effect is generated in the frequency domain. When n is in the period 3, the transmitted signal x[n] is again multiplied by the linear area of the window W(n).

Whereas the total length of the SC-FDMA symbol is N+Np, the length of the window is N+Np+Nw. To prevent the time delay caused by the data increase, the window tail of the previous window overlaps with the window head of the next window. Therefore, the time delay is not occurred. The lengths of the window head and the window tail are the same in this example, but the lengths could be different and selecting proper lengths are a design choice to a person in the ordinary skill in the art.

The band limiting is achieved by applying the rectangular window W(n) to the transmitted signal x[n]. The actual transmitted signal is x[n] multiplied by W(n).

Only rectangular window was introduced for an illustration purpose here. However, the window can be any type including Gauss, Hamming, Hann, Bartlett, Triangular, Bartleft-Hann, Blackman, Kaiser, Nuttall, Blackman-Harris, Blackman-Nuftall, Flat top, Bessel and Sine.

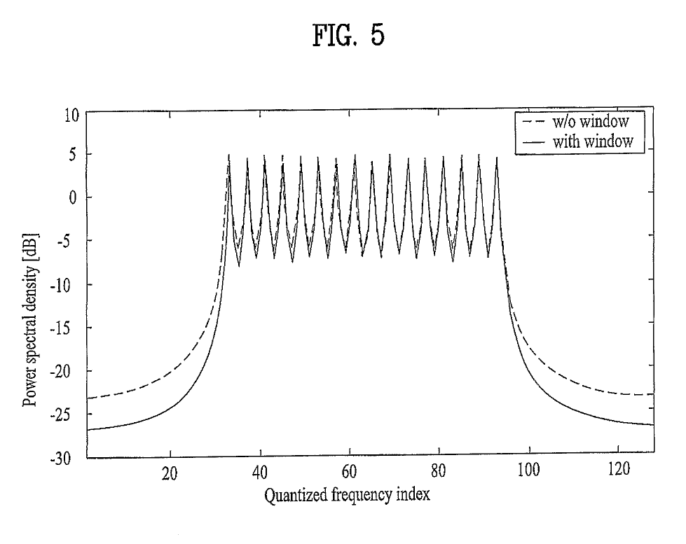

FIG. 5 shows a band limiting effect when a window is used, compared when a window is not used. In this graph, the length of SC-FDMA symbol is 64 and the length of the window is 10. As shown in the graph, the power spectral density in the excess bandwidth which is the outside of signal bandwidth is reduced when the window is used (the continuous line).

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for band limiting in a Single Carrier Frequency Division Multiple Access (SC-FDMA) communications system comprising:
generating a SC-FDMA data symbol block; and
band-limiting the SC-FDMA data symbol block using a window.

2. The method of claim 1, wherein the SC-FDMA data symbol block is generated by a Discrete Fourier Transform (DFT) spreading.

3. The method of claim 1, wherein the window is one of linear and non-linear.

4. The method of claim 1, wherein the window is one of Gauss, Hamming, Hann, Bartleft, Triangular, Bartleft-Hann, Blackman, Kaiser, Nuftall, Blackman-Harris, Blackman-Nuttall, Flat top, Bessel and Sine windows.

5. The method of claim 1, wherein the window is
$$W ( n ) = \frac{n}{Nh} , 1 \leq n \leq Nh 1 , Nh + 1 \leq n \leq N + N p + Nh \frac{( Nh + N + N p + Nt - n )}{Nt} , N + N p + Nh + 1 \leq n \leq N + N p + Nh + Nt$$
where n is an index number of each SC-FDMA symbol, Nh is the length of a window head, Nt is the length of a window tail, N is the number of SC-FDMA symbols in an information interval and Np is the number of SC-FDMA symbols in a guard interval.

6. The method of claim 1, wherein the SC-FDMA data symbol block comprises a guard interval and an information interval.

7. The method of claim 1, wherein a length of the window depends on a length of the SC-FDMA data symbol block.

8. The method of claim 4, wherein Nh and Nt have the same length.

9. The method of claim 7, wherein the window overlaps with a next window by Nh or Nt in order to avoid a time delay.

10. The method of claim 1, wherein the band limiting is acquired by multiplying the SC-FDMA data symbol block by the window.

11. The method of claim 1, wherein the SC-FDMA includes an Interleaved Frerquency Division Multiple Access (IFDMA).

12. The method of claim 11, wherein the DFT spreading generates equidistant subcarriers.

13. A transmitter in a Single Carrier Frequency Division Multiple Access (SC-FDMA) communications system comprising:
a SC-FDMA data symbol block generator which generates a SC-FDMA data symbol block; and
a window for band limiting the SC-FDMA data symbol block.

14. The transmitter of claim 13, wherein the SC-FDMA data symbol block generator includes a Discrete Fourier Transform (DFT) spreader.

15. The transmitter of claim 13, further comprising an encoder and an interleaver.

16. The transmitter of claim 13, further comprising a modulator

17. The transmitter of claim 13, further comprising a serial-to-parallel processor and a parallel-to-serial processor.

18. The transmitter of claim 13, further comprising a guard interval adder.

19. The transmitter of claim 13, wherein the band limiting is acquired by multiplying the SC-FDMA data symbol block by the window.

20. The method of claim 1, wherein the SC-FDMA includes an Orthogonal Frequency Division Multiplexing (OFDM)—Frequency Division Multiple Access (FDMA).
